(19) United States
(12) Patent Application Publication
(10) Pub. No.: US 2011/0110384 A1
(43) Pub. Date: May 12, 2011

(54) METHOD AND RECEIVER FOR THE MULTI-PATH DETECTION IN CODE DIVISION MULTIPLE ACCESS SYSTEM

(76) Inventors: Chao Li, Beijing (CN); Kangqiang Gao, Beijing (CN); Chaolun Xu, Beijing (CN)

(21) Appl. No.: 12/599,505

(22) PCT Filed: Apr. 27, 2007
(86) PCT No.: PCT/CN2007/001421

§ 371 Date: Jan. 27, 2011

(30) Foreign Application Priority Data
Apr. 9, 2007 (CN) 200710090836.5

(51) Int. Cl. H04J 13/00

(52) U.S. Cl. 370/479

(57) ABSTRACT

A method for the multi-path detection in code division multiple access system is provided, and the method includes the following step: A, initially detecting multi-path for the sample points in the searching area, obtaining the sample points for processing peak detection (300); B, detecting whether the current nonzero points Pi and Pi+3 are both the partial peak (302), if yes, detecting the partial double peak (304), if no, detecting the partial single peak (303); C, buffering the delay and power information of nonzero sample points that are detected peak (305); D, judging whether the peak detection is ending (306), if ending, outputting the position and power information of multi-path that are buffered (308); or else, making the Pi+1 and Pi+4 as new Pi and Pi+3 (307), returning step B. A receiver of code division multiple access is also provided at the same time.

### TECHNOLOGY FIELD

This invention is a multi-path detection technology, in specific, it is a multi-path detection method and receiver in code division multiple access system (CDMA).

### BACKGROUND TECHNOLOGY

CDMA technology features high capacity, multiple clients and soft capacity. It also has the advantage of restraining the noise in the system band. Comparing with the conventional frequency division multiple access (FDMA) and time division multiple access technologies, CDMA has obvious advantage. Because of this, the 3^{rd} generation (3G) of mobile communication system that is based on CDMA technology becomes the mainstream commercial mobile wireless communication system that has been making great progress.

In the wireless communication system that uses CDMA, while being transmitted in the air, on one hand, the wireless signals will be blocked, refracted, reflected and scattered by the barriers and ionospheres, on the other hand, the frequency domain of the band-limited signal may shift and expand. Therefore, the signal received by the receiver is not the direct, one-path signal, actually, it is a multi-channel signal that comes from different directions and different paths. The original data transmitted in the multi-channel signal are the same, but with different delay. They are the stacking of the copies of the signals that are independent to each other. Normally, we call these signals that have same data sources but different paths multi-path signals.

In the direct sequential code division multiple access (DS-CDMA) system, since the data signal is extended by long Pseudorandom (PN) sequences, so each chip lasts very shortly, thus, signals that are transmitted to the receiver through different paths will be effectively separated on the chips. Therefore, if the signals in each channel can be accurately tracked, then treat and integrate the signals in each channel by Rake receiver with multiple receiving fingers, then, the interference caused by the mixing and stacking of multi-path can be converted to gains after integrating through multi-path Rake. Here, the operation of tracking signals in each channel is called multi-path search. Therefore, in order to reduce the interference cause by multi-path mixing and stacking, the main function of the multi-path searching is to detect the most important multi-path vector as accurate as possible, without omitting. The accuracy is to be ½ chip at least.

Normally, according to the multi-path delay, we call the multi-path that are only 1-2 chips apart short delay multi-path and we call the multi-path that are more that 2 chips apart long delay multi-path. At present, in an urban setting, the main multi-path distribution is within 3 ms. In a suburb setting, it is within 0.5 ms. It is within 0.2 ms in a building. Under the access setting of multi-path attenuating transmission that is given by 3GPP, there is even the situation that 4 consecutive paths are only 1 chip apart. Apparently, in terms of 3G standard, short delay multi-path is more often in the practice.

For the short delay multi-path, due to the existence of the side-lobe in the time domain, in the practical application, more crosstalk will be applied toward each other. In details, since all wireless signals have a certain band limitation, therefore, the signal must be filtered by chip shaping filter before sending out, in order to limit the signal band to the design range. Meanwhile, according to Fourier Transforms, signals with the limited band can not be limitless narrow in the time domain. FIG. 1 shows the impulse response of the root raised cosine filter when the roll-off factor is 0.22. From the figure, we can see that the side-lobe of the impulse response has obvious impact on the signals in the conjoint 2 chips, and has the greatest impact on the signals in the conjoint 1 chip. It is even comparable to the signal itself. Apparently, in the practice, the multi-path peak must be impacted by the short delay multi-path crosstalk.

FIG. 2A shows the sketch of the impulse of the single path power response. FIG. 2B to FIG. 2D show respectively the sketches of double path interference stacking that is 1, 1.5, 2 chips apart of time. The abscissa axis of FIG. 2A to FIG. 2D is time delay, the unit is chip. The ordinate axis is the normalized power. In FIG. 2A, the curve represented by the solid line is single impulse response, Pi is the currently detected peak, Pi−1 and Pi+1 are respectively the side-lobes that are conjoint to both sides of the peak Pi. FIG. 2B is the interference stacking of the double path signals that are 1 chip apart, in which, the curve represented by the solid line is the power response Py(t) of the received signal. The curve represented by a dashed line is the actual power response P1(t) of a signal. The curve represented by dotted line is the actual power response P2(t) of another signal. As shown in FIG. 2B, when two paths are 1 chip apart, the power response Py(t) of the received signal has been obviously different from the actual signal response P1(t) and P2(t), the peak Py(t) that is stacked by P1(t) and P2(t) is higher than the real peak of multi-path responses P1(t) and P2(t). Most present technologies detect partial maximum peak sample point, therefore, if detecting according to the current technology, Py(t) will be kept and P1(t) and P2(t) will be deleted. This will cause detection errors and detection omits. In this case, the deviation of the multi-path detection error is ½ chips. In which, detection errors are also called false alarm; detection omits are also called false dismissal. FIG. 2C and FIG. 2D show same problem exists when at 1.5 and 2 chips apart.

Certainly, for the problems shown in FIG. 2B-2D, we can also correct by using multi-path tracking sector to the multi-path that occurs deviation. For example, the commonly used delay lock loop (DLL). However, if using this method, we must add the multi-path tracking sector, but still, the correction might not be fully achieved. The reason is: the common multi-path tracking method will take a long time to achieve in order to realize the convergence, and, if the multi-paths are closely apart, the crosstalk will often cause the tracking position unable to converge correctly. As shown in FIG. 2B, if the peak of P1(t) and P2(t) are deleted, and the peak of Py(t) is kept, even if the multi-path tracking functions well, only one path of P1(t) or P2(t) can be locked, the other path will be omitted. Therefore, if detection is conducted according to the present technology, the system performance will suffer a heavy loss.

According to the abovementioned analysis, under the condition of short delay, transformation between the multi-paths due to the side-lobe crosstalk is almost inevitably. However, the present technology can not effectively detect and distinguish the authenticity of the partial peak. Therefore, under the condition of short delay, enormous detection errors will occur, causing significant increase of the probabilities of false alarm and false dismissal.

### CONTENT OF THE INVENTION

Due to abovementioned reason, this invention is mainly to provide a multi-path detection method in the CDMA system. It can reduce the burden of the multi-path tracking. Meanwhile, effectively reduce the probabilities of false alarm and false dismissal under the short delay condition.

The other purpose of this invention is to provide a CDMA receiver, it can reduce probabilities of both false alarm and false dismissal.

In order to achieve the above purposes, the technical solution of this invention is achieved by: This invention provides a multi-path detection method in the CDMA system, the method includes:

A. Performing multi-path detection to all sample points in the current searching area, obtaining peak detection sample points;
B. Detecting to see if the current read nonzero sample points Pi and Pi+3 are both partial peaks, if yes, then performing partial double peaks detection, otherwise, performing partial single peak detection;
C. Buffering the delay information correspondent to the nonzero sample point Pi obtained from the peak detection;
D. Judging if the peak detection is ending, if yes, then outputting the buffered delay and power information, otherwise, reading the next nonzero sample point as the new Pi and Pi+3, then returning to step B.

Between step A and B, the method also includes: sort the sample points obtained in step A by sequential order, and read the nonzero sample points Pi and Pi+3 in order, in which, the initial value of i is 1.

In the above solution, the forgoing multi-path initial detection further includes:

A1. From the power values of all the sample points in the current searching area, finding the L^{th} maximum power value PL, accumulating the power values of the sample points that are less than PL, then getting the average value S of the accumulated values;
A2. Calculating the initial detection threshold, set all the power values of the sample points that are lower than the initial detection threshold as zero, then set the zeroed power sample points and non-zeroed power sample points as the peak detection sample points.

In which, the forgoing initial detection threshold is the product of the average S and the parameter λ, and, λ is a real number within [1,100].

In the above solution, step A1 includes:

A11. Sorting the power value of each sample point in the searching area by sequential order, set the initial values of the loop variables S and M as 0, finding the L^{th} maximum power value PL from the power of all the sample points;
A12. Comparing PM and PL, if PM<PL, then accumulate PM into S, going to step A13, otherwise, going to step A14;
A13. Judging whether all the sample points have been read, if yes, then going to step 15; otherwise, going to A14;
A14. Adding 1 to M, then returning to step 12;
A15. Calculating and outputting S's average;

In the above solution, the details of the step B, to detect whether the current read nonzero sample points Pi and Pi+3 are both the partial peaks, are as followings:

B11. Judging if Pi>0 and Pi>Pi+3, if not, then Pi is not a partial peak, ending the current judging process; if yes, then going to step B12;

B12. Judging if Pi+3>0 and Pi+3>Pi+2 and Pi+3>Pi+4, if yes, then Pi and Pi+3 are both partial peaks, if not, then Pi+3 is not a partial peak.

Accordingly, the detail of the forgoing partial double-peak detection in step B is: setting the power of the conjoint sample points that are before and after Pi and Pi+3 to 0; the detail of the forgoing partial single peak detection in step B is:

B21. Judging if Pi−1<SinglePath_Th.Pi and Pi+1<SinglePath_Th.Pi, if yes, then going to step B23, if not, then going to step B22; in which, SinglePath_Th is the single path threshold;

B22. Judging if MAX (Pi−1, Pi+1)>ShortDelay_Th1.Pi and MIN (Pi−1, Pi+1)>ShortDelay_Th2.Pi, if yes, then going to step 24, if not, then going to B23; in which, ShortDelay_Th1 and ShortDelay_Th2 are respectively short delay threshold 1 and short delay threshold 2;

B23. Setting Pi−1, Pi+1 to 0 respectively, going to step B25;

B24. Setting the side path Pi−2, Pi+2 of the fake peak Pi and two real multi-path peaks to 0, going to B25;

B25. Outputting the detected power.

In which, the forgoing single path threshold SinglePath_Th is P (Tc/2)+δ, in which, δ is the noise residuals, δε(0, 0.03); the forgoing short delay threshold 1 ShortDelay_Th is (1/2r)²+δ1, short delay threshold 2 ShortDelay_Th2 is (1/r−1)²+δ2, δ1 and δ2 are noise residuals, δ1ε(0, 0.2), δ2ε(0, 0.08).

In the above solution, between step B and C, it further includes the step of the detection of the conjoint sample points, the detail is as:

B31. Reading the delay power Pi stored after partial peak detection, in which, the initial value of i is 0;

B32. Detecting if Pi>0 and Pi+1>0, if yes, then judging if Pi>Pi+1, if yes, then setting Pi+1 to 0, otherwise, setting Pi to 0; if not, then going to step B33;

B33. Judging if the conjoint sample points detection is ending, if yes, then going to step C; if not, adding 1 to I, then returning to step B31.

This invention also provides a code division multiple access receiver, including RF front end, N multiples oversampler, Rake receiver & processor, its character is, the receiver also includes:

Receiving filter, used to receive, match and filter the signals after oversampling by the oversampler, and send the matched and filtered signals to multi-path searcher, multi-path tracker and Rake receiver; Multi-path searcher, used to roughly search the delay position of each multi-path signal and send the found multi-path delay position to the multi-path administrator;

Multi-path administrator, used to administer, coordinate and distribute the found multi-path delay information, and send the multi-path delay position to multi-path tracker;

Multi-path tracker, used to track the multi-path position provided by multi-path administrator and perform fine synchronization, and sending the accurate multi-path position information to Rake receiver and sending feedback to multi-path administer.

The multi-path searcher further includes:

2-times baseband rate extractor, used to extract the 2 times baseband rate of the N times sampling data; Correlator, used to calculate the related value of the sample point;

Delay power spectrum generator, used to calculate the power spectrum of the related value of the sample point;

Initial detector, used to perform initial detection to the power spectrum of the sample point;

Peak detector, used to perform peak detection to the power spectrum of the sample point;

Data that is processed by receiving filter is extracted by 2 times baseband rate extractor, then the data information of 2-times oversampling is obtained. In the correlator, the related value of each sample point is calculated by the obtained data and the local tailing code. Related power detection is performed to each related value through the delay power spectrum generator, then successively through the initial detector and the peak detector.

In the above design, the forgoing peak detector further includes:

Power sequencer, used to sort the sample power Pi which is obtained by initial detection in sequential order, and then successively send the sorted sample point power to the partial peak judger;

Partial peak judger, used to determine if Pi, Pi+3 are partial peaks, and if at least Pi is determined to be a partial peak, trigger the partial peak detector to complete the partial peak detection;

Partial peak detector, used to perform partial single peak or double peak detection, and trigger the conjoint sample value detector after completing the peak detection;

Loop variable processor, used to initialize the loop variables or control the gradual increase of the loop variables;

Conjoint sample value detector, used to set the power of the sample point in which its power is larger than 0 but comparably less than its conjoint peak to 0, and control to complete the detection to all conjoint sample points;

Delay information processor, used to buffer and output the peak power information Pi of all larger-than-zero peak after the conjoint sample point detection and the correspondent delay information Ci.

This invention provides a multi-path detection method and receiver in the CDMA system. By setting 3 thresholds, it can effectively distinguish the long, short delay multi-paths, meanwhile, to accurately judge the authenticity of the partial peak under the short delay condition, avoiding the problem that the present technology is unable to effectively distinguish the long delay multi-path and the short delay multi-path as well as the fake peak generated by the stacking of two multi-paths is higher than the real peak of two multi-peaks. This invention can reduce the probabilities of both false alarm and false dismissal. It is easy and is effective in lightening the burden of the multi-path tracking sector.

### BRIEF DESCRIPTION OF THE DRAWINGS

FIG. 1 is the sketch of impulse response of the root raised cosine filter;

FIG. 2 is the sketch of the impulse of the single path power response;

FIG. 2A is the sketch of the double path interference stacking at 1 chip apart;

FIG. 2B is the sketch of the double path interference stacking at 1.5 chips apart;

FIG. 2C is the sketch of the double path interference stacking at 2 chips apart;

FIG. 3 is the sketch of the process of the multi-path detection method in this invention;

FIG. 4 is the sketch of the process of the initial detection average calculation in this invention;

FIG. 5 is the sketch of the initial detection result in this invention;

FIG. 6 is the process sketch of the preferred embodiment of the multi-path peak detection in this invention;

FIG. 7 is the sketch of the process of the partial single peak detection;

FIG. 8 is the structural sketch of the composition of the receiver of the CDMA system in this invention;

FIG. 9 is the structural sketch of the composition of the multi-path searcher in this invention.

### DETAILED DESCRIPTION OF THE PREFERRED EMBODIMENT

The principal of this invention is: performing detection to the multi-path peaks after undergoing the initial detection. While detecting, separate the multi-path peaks as partial double peaks and partial single peak. For the partial double peaks, keeping 2 largest double peaks; for the partial single peaks, if it can pass both long delay single path threshold and two short delay double paths threshold, then delete it, meanwhile, keeping the conjoint multi-path peaks that are at both sides of it and at ½ chips apart, otherwise, keeping the partial single peak at this time.

There are two circumstances to keep the partial single peak: one is the partial single peak that can not pass the long delay single path threshold, the other is the partial single peak that can pass the long delay single path threshold but can not also pass two short delay double path threshold.

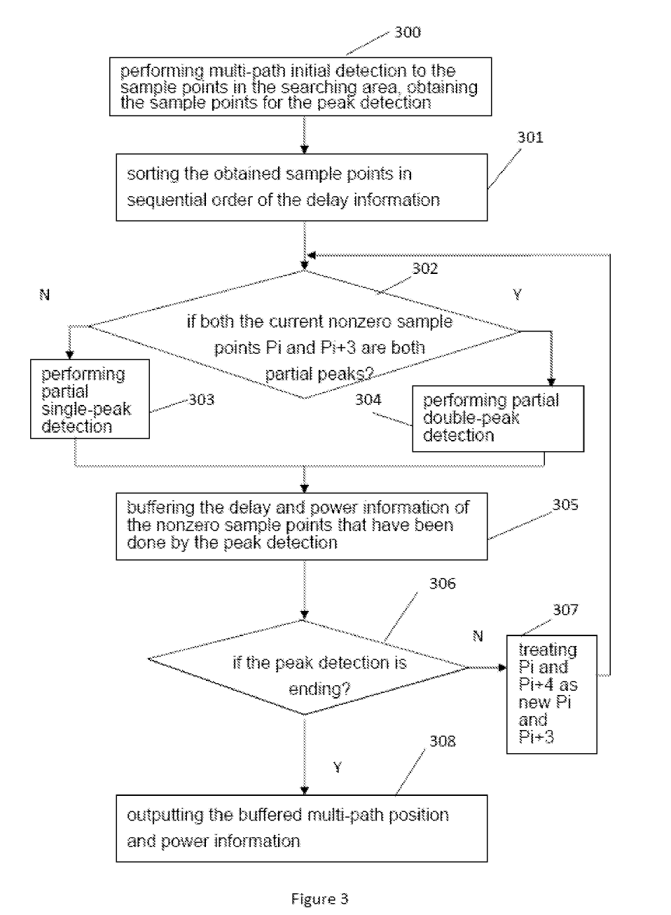

FIG. 3 is the sketch of the process of the multi-path detection in this invention. As shown in FIG. 3, the multi-path detection method in this invention includes following steps:

Step 300: performing multi-path initial detection to all the sample points in the current searching area, obtaining the sample points for the peak detection;

Step 301: sorting the sample points obtained from the multi-path initial detection in sequential order, the initialized loop variable i=1, then reading the nonzero sample points Pi and Pi+3 in order; here, the forgoing delay information is the position of the multi-path;

Step 302-304: Detecting to see if the currently read nonzero sample points Pi and Pi+3 are both partial peaks, if not, then performing the partial single peak detection; if yes, then performing the partial double peak detection. Here, the forgoing “no” means Pi is a partial peak point, but Pi+3 is not, because the data stored in the memory is read in the order of their addresses;

Step 305: buffering the delay information that is correspondent to the nonzero sample points obtained by single path and multi-path peak detection;

Step 306-308: judging if the peak detection is ending, if yes, then outputting the buffered multi-path power information and delay information (position information) for post processing, otherwise, reading the nonzero sample points Pi+1 and Pi+4 that is conjoint to Pi and Pi+3 in order, setting the read nonzero sample points Pi+1 and Pi+4 as new Pi and Pi+3, then returning to step 302.

In the process shown in FIG. 3, the forgoing sorting in step 301 is mainly for easy operation and to avoid the omits of the data that is supposed to be processed. Therefore, it can be omitted in the practical application, only to make sure that all the nonzero sample points can be processed. Accordingly, if don't perform sorting, the forgoing Pi+1 and Pi+4 in step 308 may not be the next nonzero sample point that is conjoint to Pi and Pi+3, only if they are nonzero sample points that have not been processed.

From the process in FIG. 3, we learn that the invention is to perform the multi-path initial detection first, then perform peak detection.

In which, the process of multi-path initial detection includes:

Step 401: From the power of all the sample points in the searching area, finding the L^{th} largest power PL, accumulating the sample point power that is smaller PI, then calculating the average S of the accumulated values.

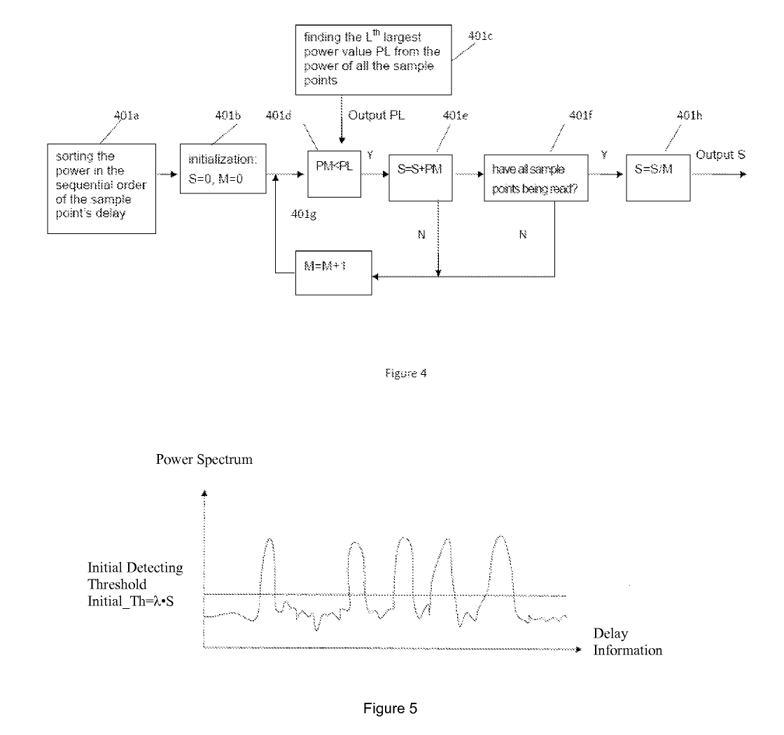

In this step, the detailed method of the forgoing calculation of the sample point average is as shown is FIG. 4, includes:

Step 401a: sorting the power of all the sample points in the searching area in sequential order:

Step 401b: setting the initial values of loop variables S=0, M=0; Step 401c: finding the L^{th} largest power PL from the power of all the sample points, in which, the value of L is determined by the adopted times of oversampling and the number of finger of RAKE receiver. In this invention, L equals to the number of finger of the receiver, normally less than 8.

Step 401d-401e: comparing the currently read sample power PM and PL, if PM<PL, then accumulating PM to S, if S=S+PM, then going to step 401f; otherwise, going to step 401g, reading the next PM, until reading all the power samples.

Step 401f: Judging if all the samples have been read, if yes, then going to step 401h; otherwise, going to step 401g;

Step 401g: accumulating the loop variable M, that is to make M=M+1, then returning to step 401d;

Step 401h: calculating and outputting the average of S.

In the above-mentioned steps, steps 401a-401c can be performed at the same time, no order of time.

Step 402: Calculating the initial detection threshold Intial_Th=λ*S, in which, λ is a real number in [1, 100].

FIG. 5 shows the resulted curve after the initial detection, this is: using the averaged S to times parameter λ, calculating the initial detection threshold Initial_Th.

Step 403: set all the power of the sample points that are lower than the initial detection threshold as 0, keeping other power sample points that are higher then Initial_Th, then set the power sample points that are set 0 and not set 0 as the sample points for the peak detection.

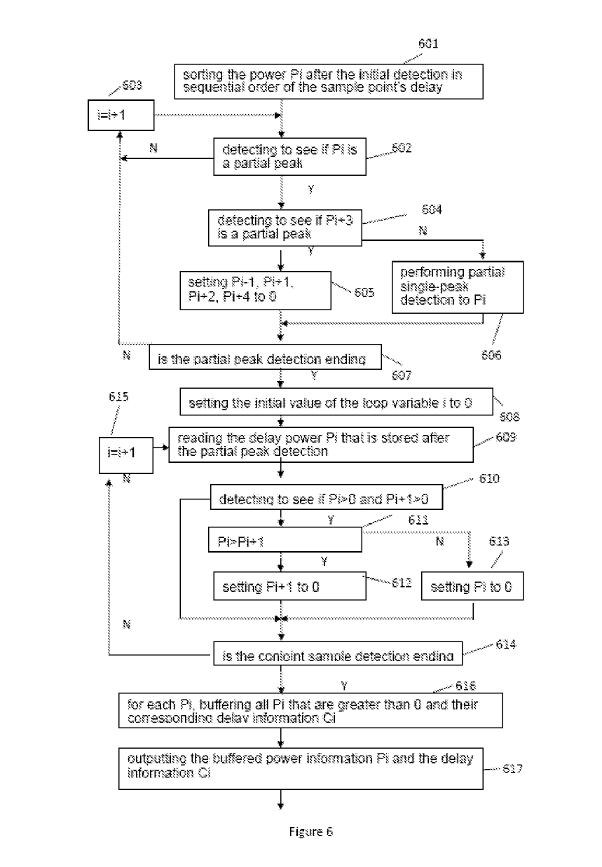

For the peak detection, the detailed process is shown in FIG. 6, including following steps:

Step 601: sorting the sample point power Pi obtained from the initial detection in sequential order, initial loop variable i=1.

Step 602-603: detecting if Pi is a partial peak, that is: judging if Pi>0 and Pi>Pi−1, if not, then adding 1 to loop variable, then returning to step 602 and detecting if the next sample point power is a partial peak; if yes, then performing step 604.

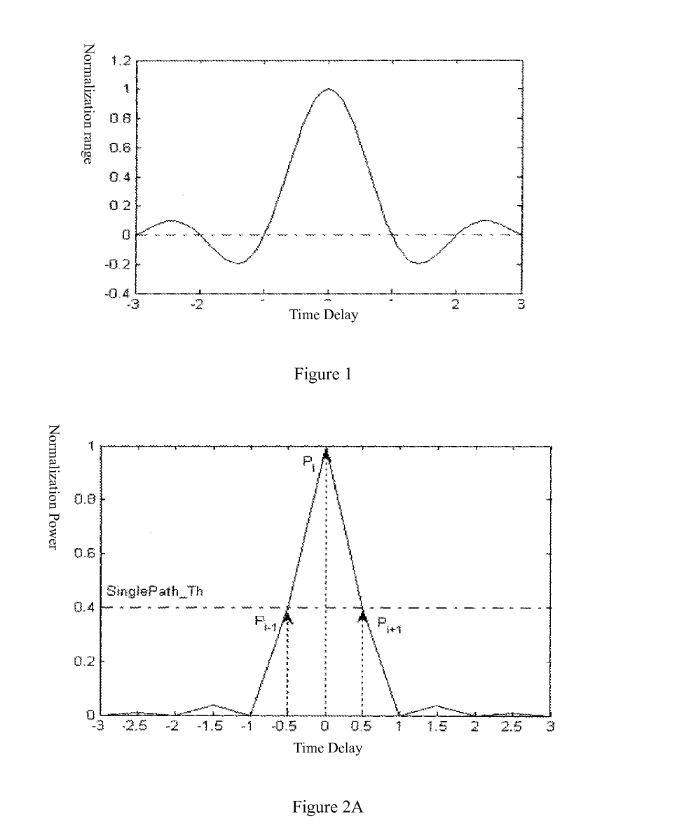

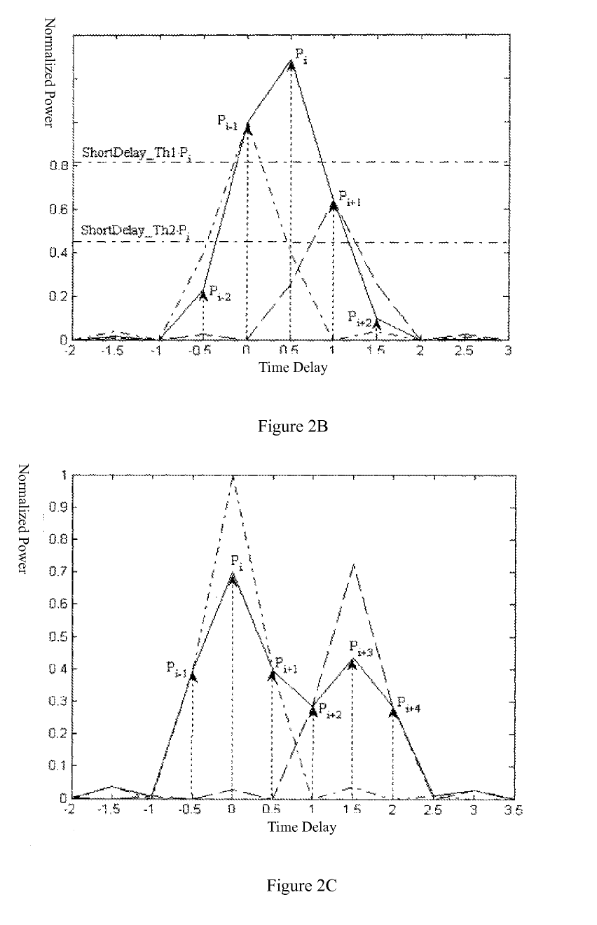

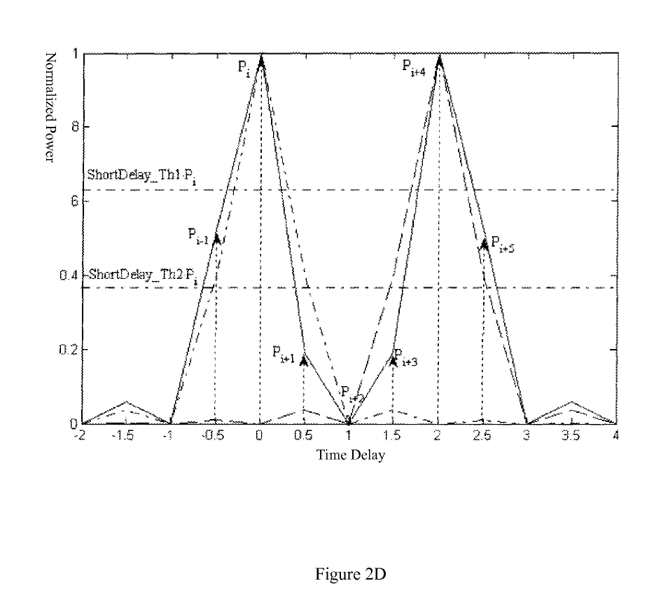

Step 604-606: detecting if Pi+3>0 and Pi+3>Pi+2 and Pi+3>Pi+4, if yes, as shown in FIG. 2C, meaning the Pi and Pi+3 are both real peaks, then setting Pi−1, Pi+1, Pi+2, Pi+4 to 0; if not, then performing partial single peak detection to Pi.

Step 607-609: judging if the partial peak detection is ending, if yes, then setting the loop variable i to 0, reading the stored delay power Pi from the partial peak detection; if not, then returning to step 603. Here, the forgoing judgment refers to: judging the if all the sample point power have been read in the partial peak detection, that is, judging if the loop variable I has pointed to the bottom of the memory.

Step 610-613: detecting to see if Pi>0 and Pi+1>0, if yes, also judging if Pi>Pi+1, if yes, then setting Pi+1 to 0, otherwise, setting the Pi to 0; if not, then going to step 614.

Step 614-615: Judging if the conjoint detection has been finished, if yes, then going to step 616, if not, then adding 1 to i, then returning to step 609.

Step 616-617: calculating the delay information Ci correspondent to all the peak power information Pi that is greater than 0 and buffering Pi, Ci, outputting the buffered power information Pi and delay information Ci for past processing, such as administering, coordinating and distributing the multi-path information.

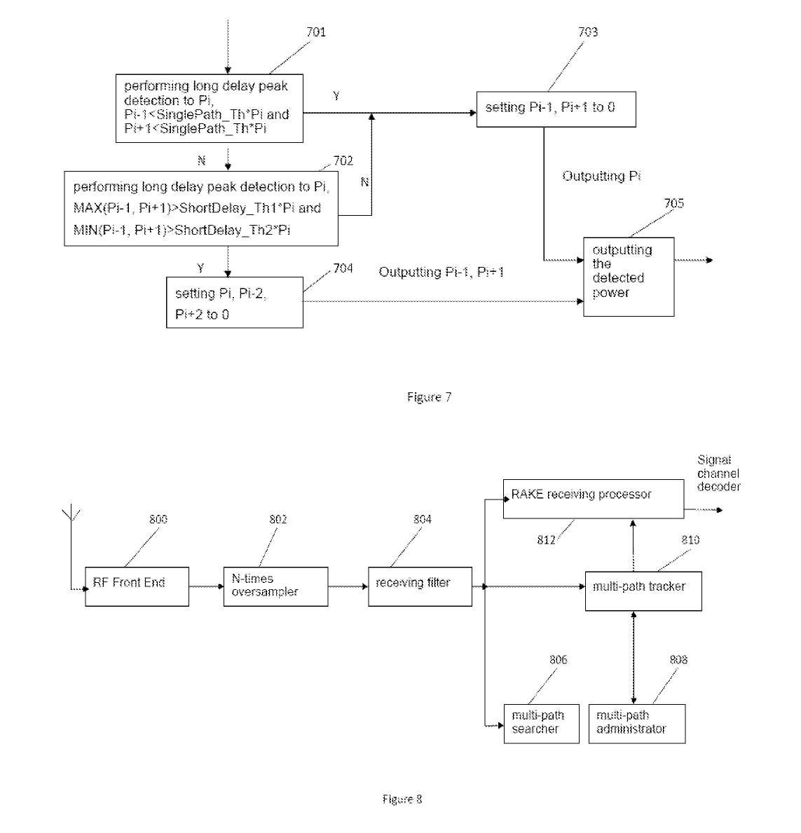

For the partial single peak detection mentioned in step 606, the detailed detection process is shown in FIG. 7, including following steps:

Step 701: Judging if Pi is a peak generated by long delay single path, as shown in 2A, then the distance of the delay between two paths is greater than 2 chips, then Pi can be regarded as a single peak. In this case, only need to judge if Pi−1<SinglePath_Th.Pi and Pi+1<SinglePath_Th, if yes, meaning this is a long delay single path peak as shown in FIG. 2A, then going to step 703; if not, meaning short delay double path stacking exists, in this case, Pi is a fake peak stacked by conjoint double path stacking, as shown in 2B, going to step 702.

In this step, SinglePath_Th is a single path threshold, SinglePath_Th can be calculated by following method:

Supposing the unit impulse response of the filter is h(t), the power spectrum of the response is P(t)=h²(t). As shown in FIG. 2A, Single path threshold SinglePath_Th=P (Tc/2)+δ, in which, δ is the noise residuals, δ is relevant to the lowest signal to noise ratio (SNR) of the system design and the calculation of the related length, it can be determined by system simulation, normally δε(0, 0.03). For the root-raised cosine filter with roll-off system α=0.22.P(Tc/2)=0.3962, in this case, SinglePath_Thε(0.3962, 0.4262).

Step 702: performing short delay peak detection to Pi, that is, judging if MAX(Pi−1, Pi+1)>ShortDelay_Th1.Pi and MIN(Pi−1, Pi+1), if yes, then going to step 704; if not, meaning although the current peak Pi is impacted by the stacking of the conjoint multi-path, but the stacked two paths does not exceed the peak of the two real paths, as shown in FIG. 2D, in this case, the detected peak is the real peak of the multi-path, therefore, going to step 703.

In this step, ShortDelay_Th1 and ShortDelay_Th2 are respectively two short delay single path threshold: short delay threshold 1 and short delay threshold 2, the values of ShortDelay_Th1 and ShortDelay_Th2 can be calculated by following method:

Supposing the unit impulse responses of the two short delay single path are respectively h1(t)=h(t), h2(t)=β.h(t−Tc), 0<β≦1, then the actually received impulse response hy(t)=h(t)+β.h(t−Tc). As shown in FIG. 2B, using Pi−1, Pi+1, P1 to represent the power peaks of the two single paths and the power peak of the actual response stacked in the middle by the two single paths, therefore, Pi=[h(Tc/2)+β.h(−Tc/2)]², Pi−1=h²(0), Pi+1=β².h²(0). The condition under which the stacked value exceeds the two real multi-path peaks is:

$$\{ \begin{matrix}{P}_{i} > {P}_{i - 1} \\ {P}_{i} > {P}_{i + 1}\end{matrix} ⇒ \{ \begin{matrix}{( γ + β \cdot γ )}^{2} > 1 \\ {( γ + β \cdot γ )}^{2} > {β}^{2}\end{matrix} , ( γ = \frac{h ( {T}_{c} / 2 )}{h ( 0 )} , 0 < β \leq 1 )$$

By resolving the equation, we get 1/γ−1<β≦1, further:

$$\{ \begin{matrix}\frac{MAX ( {P}_{i - 1} , {P}_{i + 1} )}{{P}_{i}} = \frac{1}{{( γ + γ \cdot β )}^{2}} ∈ [ \frac{1}{{( 2 γ )}^{2}} , 1 ) \\ \frac{MIN ( {P}_{i - 1} , {P}_{i + 1} )}{{P}_{i}} = \frac{{β}^{2}}{{( γ + γ \cdot β )}^{2}} ∈ ( {( \frac{1}{γ} \cdot 1 )}^{2} , \frac{1}{{( 2 γ )}^{2}} ]\end{matrix}$$

Setting the short delay threshold 1 and short delay threshold 2 as respectively ShortDelay_Th1=1/(2γ)²+δ1,

ShortDelay_Th1=1/(2γ)²+δ2, δ1 and δ2 are set as noise residuals, is relevant to SNR of the system design and the calculation of the related length, it can be determined by system simulation, normally δ1ε(0, 0.2), δ2ε(0, 0.08). For the root-raised cosine filter with roll-off coefficient α=0.22. γ=0.6294, in this case, SinglePath_Thε(0.347, 0.427).

Step 703: Setting Pi−1, Pi+1 as 0, then going to step 705;

Step 704: setting the fake peak Pi and side paths of the two real multi-path peaks Pi−2, Pi+2 to 0, then going to step 705;

Step 705: Outputting the detected power.

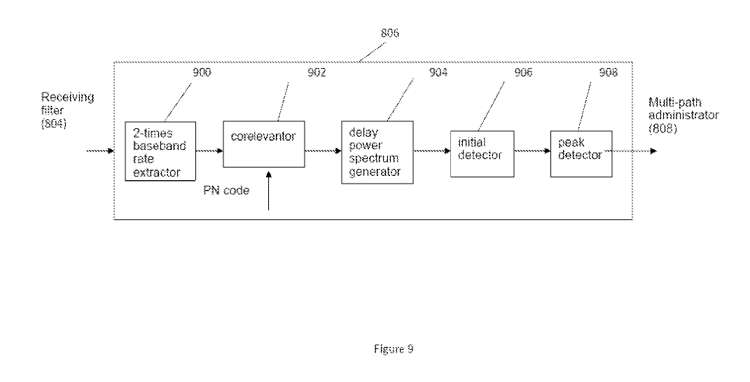

In order to realize the multi-path detection method in this invention, the invention presents a structure of the CDMA receiver, as shown in FIG. 8. The CDMA receiver in this invention includes a RF front end 800, N times oversampler 802, receiving filter 804, multi-path searcher 806, multi-path tracker 810, multi-path administrator 808 and RAKE receiving processor 812. In which, the RF Front End 800 is used to finish the processing of the receiving FR, that is: to finish data's conversion from electro-magnetic signal to baseband signal. The processed signal, through N times oversampler 802, is sent to receiving filter 804. The N-times oversampler 802 is used to realize the N-times oversampling of the baseband signal, in which, N should not be less than 2. The receiving filter 804 is used to finish the receiving, matching and filtering of the signal after oversampled by the N-times oversampler 802. If the sending end uses root-raised cosine (RRC) filter, then RRC filter should also be used on the receiving end. The filtered signal has the same effect as the sending signal that is filtered by RRC. The multi-path searcher 806 is used to roughly search the delay position of each multi-path signal, and send the found multi-path delay position to the multi-path administrator, normally the accuracy is not lower than ½ chip. The multi-path administrator 808 is used to administer, coordinate and distribute the found multi-path delay information and provide the multi-path delay position to the multi-path tracker 810. The multi-path tracker 810 is used to track the multi-path delay position provided by multi-path administer 808 and perform fine synchronization. It provides the various tracked accurate multi-path delay position information to RAKE receiving processor 812 and feed back to multi-path administer 808. Normally its accuracy is not lower than ⅛ chip. The RAKE receiving processor 812 is used to realize the demodulation and integration of data.

The signal that is oversampled by N-times oversampler 802, after being matched and filtered in receiving filter 804, is divided into 3 paths: one path is processed in multi-path searcher 806, multi-path administrator 808, obtaining rough multi-path position information; one path is under the control of the multi-path administrator 808, processed by multi-path tracker 810, obtaining the accurate value of each path delay information, in this case, the baseband data in the same path is sent to multi-path searcher 806 and the multi-path tracker 810 as the input data; the other path is to send the data that is processed by receiving filter 804 to RAKE receiving processor 12, and finish the demodulation of the baseband data under the control of the delay information outputted by the multi-path tracker 810. Date that is demodulated by RAKE receiving processor 812 is finally sent to the channel decoder for decoding to recover the sent data.

In the CDMA receiver presented in this invention, the multi-path searcher 806 has the unique composition structure of this invention. It differs from the present technology. FIG. 9 is the structural sketch of the composition of the multi-path searcher in this invention, as shown in FIG. 9. The multi-path searcher in this invention includes: 2-times baseband rate extractor 900, correlator 902, delay power spectrum generator 904, initial detector 906 and peak detector 908. In which, the 2-time baseband rate extractor 900 is used to realize the 2-times baseband rate extraction of the N-times sampling data. The 2-times baseband rate extractor successfully reduces the number of the to-be processed sample points, thus reduces the consumption of the system. The correlator 902 and delay power spectrum generator 904 are respectively used to realize the initial detection and peak detection of the sample point power spectrum. Data process by the receiving filter 804, through extraction of the 2-times baseband rate extractor 900, obtains the 2-times oversampling data information. The obtained data and the local PN code is used to calculate the relevant value for each sampling point. Through the delay power spectrum generator 904, each relevant value will in turn pass the initial detector 906 and the peak detector 908 for relevant power detection. In which, the process that peak detector 908 finishes the peal detection is shown in FIG. 6. The forgoing peak detector 908, from the perspective of its logic function, it includes: power sorting unit, partial peak judging unit, partial peak detecting unit, loop variable processing unit, conjoint sample detecting unit, delay information processing unit. In which, the power sorting unit is used to sort the sample point power Pi obtained by the initial detection in sequential order, and send the sorted sample point power to the partial peak judging unit. The partial peak judging unit is used to determine if Pi, Pi+3 are partial peaks, and trigger the partial peak detecting unit to finish the partial peak detection when determining at least Pi is a partial peak. The partial peak detecting unit is used to realize the partial single peak or double peak detection and trigger the conjoint sample detecting unit after finishing the peak detection.

The loop variable processing unit is used to initialize the loop variable or control the adding of the loop variable. The conjoint sample detecting unit is used to detect partial conjoint peaks to see if they are both larger than 0, set the power of the sample whose power is smaller in the 2 conjoint larger-than-0 peaks to 0 and control to finish the detection of all conjoint samples. The delay information processing unit is used to buffer and output the peak power information Pi of all the larger-than-0 peaks after the conjoint peak detection and the correspondent delay information Ci.

The above-mentioned is only the preferred embodiment of this invention. It is not used to limit the protected scope of this invention.

1. It is a multi-path detecting method in CDMA communication system, the method includes:
A. Initially detecting the multi-path for the sample points in the current searching area, obtaining the sample points for processing peak detection;
B. Detecting whether the current nonzero points Pi and Pi+3 are both partial peaks, if yes, detecting the partial double-peak, if not, detecting the partial-single peak.
C. Buffering the delay information of nonzero sample point Pi that has been done by peak detection;
D. Judging whether the peak detection is ending, if yes, outputting the buffered delay and power information; otherwise, reading next nonzero sample points as new Pi and Pi+3, returning to step B.

2. According to claim 1 of the forgoing multi-path detection method, its character is, between step A and B, the method also includes: sorting the sample points obtained from step A in sequential order and reading the nonzero sample points Pi and Pi+3 in sequential order, among them, the initial value of i is 1.

3. According to claim 1 or 2 of the forgoing multi-path detection method, its character is: the forgoing multi-path initial detection further includes:
A1. From the power of all the sample points in the current searching area, finding the L^{th} largest power PL, accumulating the power of the sample points that are less than PL, then getting the average S of the accumulated values;
A2. Calculating the initial detection threshold, setting all the power of the sample points that are lower than the initial detection threshold to zero, then setting the zeroed power sample points and non-zeroed power sample points to the peak detection of sample points.

4. According to claim 3 of the forgoing multi-path detection method, its character is: the forgoing initial detection threshold is the product of the average S and the parameter λ, and, λ is a real number within [1,100].

5. According to claim 3 of the forgoing multi-path detection method, its character is: step A1 includes:
A11. Sorting the power of each sample point in the searching area by sequential order, setting the initial value of the loop variable S and M to 0, finding the L^{th} largest power PL from the power of all the sample points;
A12. Comparing PM and PL, if PM<PL, then accumulating PM into S, going to step A13, otherwise, going to step A14;
A13. Judging whether all the sample points have been read, if yes, then going to step A15; otherwise, going to A14;
A14. Adding 1 to M, then returning to step A12;
A15. Calculating and outputting S's average;

6. According to claim 5 of the forgoing multi-path detection method, its character is: the value of the forgoing L is decided by the adopted oversampling times and the finger number of the Rake receiver.

7. According to claim 2 of the forgoing multi-path detection method, its character is: the details of the step B which is to detect whether the current read nonzero sample points Pi and Pi+3 are both partial peaks, are as followings:
B11. Judging if Pi>0 and Pi>Pi+3, if not, then Pi is not the partial peak, ending the current judging process; if yes, then going to step B12;
B12. Judging if Pi+3>0 and Pi+3>Pi+2 and Pi+3>Pi+4, if yes, then Pi and Pi+3 are both partial peaks, if not, then Pi+3 is not a partial peak.

8. According to claim 7 of the forgoing multi-path detection method, its character is: the details of the single-peak detection described in step B is as followings:
B21. Judging if Pi−1<SinglePath_Th.Pi and Pi+1<SinglePath_Th.Pi, if yes, then going to step B23, if not, then going to step B22; in which, SinglePath_Th is the single path threshold;
B22. Judging if MAX (Pi−1, Pi+1)>ShortDelay_Th1.Pi and MIN (Pi−1, Pi+1)>ShortDelay_Th2.Pi, if yes, then going to step 24, if not, then going to B23; in which, ShortDelay_Th1 and ShortDelay_Th2 are respectively short delay threshold 1 and short delay threshold 2;
B23. Setting Pi−1, Pi+1 to 0 respectively, going to step B25;
B24. Setting the side path Pi−2, Pi+2 of the fake peak Pi and two real multi-path peaks to 0, going to B25;
B25. Outputting the detected power.

9. According to claim 8 of the forgoing multi-path detection method, its character is: the forgoing single path threshold SinglePath_Th is P (Tc/2)+δ, in which, δ is the noise residuals, δε(0, 0.03).

10. According to claim 8 of the forgoing multi-path detection method, its character is: the forgoing short delay threshold 1 ShortDelay_Th is (1/2r)²+δ1, short delay threshold 2 ShortDelay_Th2 is (1/r−1)²+δ2, δ1 and δ2 are noise residuals, δ1ε(0, 0.2), δ2ε(0, 0.08).

11. According to claim 7 of the forgoing multi-path detection method, its character is: the detail of the forgoing partial double-peak detection is: setting the power of the conjoint sample points for Pi and Pi+3 to 0.

12. According to any item of claims 8 to 11 of the forgoing multi-path detection method, its character is: between step B and step C, it further includes a step of conjoint sample point detection, the detail is:
B31. Reading the stored power Pi obtained after the partial peak detection, in which the initial value of i is 0;
B32. Detecting if Pᵢ>0 and P_{I}+1>0, if yes, then judging if Pᵢ>Pᵢ₊₁, if yes, then setting Pᵢ₊₁ to 0, otherwise, setting Pᵢ to 0; if not, then going to step B33;
B33. Judging if the conjoint sample detection is ending, if yes, then going to step C; if not, then adding 1 to i, then returning to step B31.

13. According to claim 12 of the forgoing multi-path detection method, its character is: the forgoing multi-path initial detection further includes:
A1. Finding the L^{th} largest power P_{L} from all the sample point power in the searching area, accumulating the power of the sample point whose power is less than P_{L}, then, after accumulating, obtaining the average S;
A2. Calculating the initial detection threshold, setting each sample point power that is lower than the initial detection threshold to 0, then treating the power of the zeroed sample points and non-zeroed sample points as the sample points for peak detection.

14. According to claim 13 of the forgoing multi-path detection method, its character is: step A1 includes:
A11. Sorting the power of the sample points in the searching area in sequential order of the delay, setting the initial values of the loop variables S and M to 0, finding the L^{th} largest power P_{L} from all the sample point power;
A12. Comparing P_{M} and P_{L}, if P_{M}<P_{L}, then accumulating PM to S, then going to step A13, otherwise, going to step A14;
A13. Judging if all the sample points have been read, if yes, then going to step A15; otherwise, going to step 14;
A14. Adding 1 to M, then returning to step A12;
A15. Calculating and outputting the average of S.

15. It is a multi-path initial detection method in the code division access communication system, it's character is, the method includes:
a. From all the sample point powers in the current searching area, finding the L^{th} largest power P_{L}, accumulating those sample point powers that are less than P_{L}, then, getting the average S of the accumulated value;
b. Calculating the initial detection threshold, setting all the sample point powers that are less than the initial detection threshold as 0, then setting the zeroed sample points and unzeroed sample points as the sample points for the peak detection.

16. According to claim 15 of the forgoing multi-path detection method, its character is, the forgoing initial detection threshold in step b is the product of the average S and the parameter λ, and, λ is a real number within [1,100].

17. According to claim 15 of the forgoing multi-path detection method, its character is: step a includes:
a1. Sorting the power of each sample point in the searching area by sequential order, setting the initial value of the loop variable S and M to 0, finding the L^{th} largest power P_{L} from all powers of the sample points;
a2. Comparing P_{M} and P_{L}, if P_{M}<P_{L}, then accumulating P_{M} into S, going to step a3, otherwise, going to step a4;
a3. Judging whether all the sample points have been read, if yes, then going to step a5; otherwise, going to a4;
a4. Adding 1 to M, then returning to step a2;
a5. Calculating and outputting S's average.

18. According to claim 17 of the forgoing multi-path detection method, its character is: the value of the forgoing L is decided by the adopted oversampling times and the finger number of the Rake receiver.

19. It is a single peak detection method in the code division multiple access communication system, its character is, the method includes:
X1. Judging if Pᵢ₋₁<SinglePath_Th.Pᵢ and Pᵢ₊₁<SinglePath_Th.Pᵢ, if yes, then going to step X3, if not, then going to step X2; in which, SinglePath_Th is the single path threshold;
X2. Judging if MAX (Pᵢ₋₁, Pᵢ₋₁)>ShortDelay_Th1.Pᵢ and MIN (Pᵢ₋₁, Pᵢ₊₁)>ShortDelay_Th2.Pᵢ, if yes, then going to step X4, if not, then going to X3; in which, ShortDelay_Th1 and ShortDelay_Th2 are respectively short delay threshold 1 and short delay threshold 2;
X3. Setting Pᵢ₋₁, Pᵢ₊₁ to 0 respectively, going to step X5;
X4. Setting the side path Pᵢ₋₂, Pᵢ₊₂of the fake peak Pᵢ and two real multi-path peaks to 0, going to X5;
X5. Outputting the detected power.

20. According to claim 19 of the forgoing single peak detection method, its character is: the forgoing single path threshold SinglePath_Th is P(Tc/2)+δ, in which, δ is the noise residuals, δε(0, 0.03).

21. According to claim 19 of the forgoing single peak detection method, its character is: the forgoing short delay threshold 1 ShortDelay_Th1 is (1/2r)²+δ1, short delay threshold 2 ShortDelay_Th2 is (1/r−1)²+δ2, δ1 and δ2 are noise residuals, δ1ε(0, 0.2), δ2ε(0, 0.08).

22. It is a multi-path searcher, its character is, the multi-path searcher includes: 2-times baseband rate extractor, used to extract the 2 times baseband rate of the N-times sampling data;
Correlator, used to calculate the relevant value of the sample point;
Delay power spectrum generator, used to calculate the power spectrum of the relevant value of the sample point;
Initial detector, used to perform initial detection to the power spectrum of the sample point;
Peak detector, used to perform peak detection to the power spectrum of the sample point;
Data that is processed by receiving filter is extracted by the 2-times baseband rate extractor, then the data information of the 2-times oversampling is obtained. In the correlator, the relevant value of each sample point is calculated by the obtained data and the local tailing code. Relevant power detection is performed to each relevant value through the delay power spectrum generator, then successively through the initial detector and the peak detector.

23. According to claim 22 of the forgoing code division multiple access receiver, its character is: the forgoing peak detector further includes:
Power sequencer, used to sort the sample power Pi which is obtained by initial detection in sequential order, then successively send the sorted sample point power to the partial peak judger;
Partial peak judger, used to determine if Pᵢ, Pᵢ₊₃ are partial peaks, if at least Pᵢ is decided to be a partial peak, trigger the partial peak detector to complete the partial peak detection;
Partial peak detector, used to perform partial single peak or double peak detection, and trigger the conjoint sample value detector after completing the peak detection;
Loop variable processor, used to initialize the loop variables or control the gradual increase of the loop variables;
Conjoint sample value detector, used to set the those power of the sample point whose power is larger than 0 but comparably less than its conjoint peak to 0, and control to complete the detection to all conjoint sample points;
Delay information processor, used to buffer and output the peak power information Pᵢ of all larger-than-zero peak after the conjoint sample point detection and the corresponding delay information Cᵢ.

24. It is a code division multiple access receiver, including RF front end, N-times oversampler, Rake receiver & processor. Its character is, the receiver also includes:
Receiving filter, used to receive, match and filter the signals after oversampling by the oversampler, then send the matched and filtered signals to multi-path searcher, multi-path tracker and Rake receiver;
Multi-path searcher, used to roughly search the delay position of each multi-path signal and send the found multi-path delay position to the multi-path administrator;
Multi-path administrator, used to administer, coordinate and distribute the found multi-path delay information, then send the multi-path delay position to the multi-path tracker;
Multi-path tracker, used to track the multi-path position provided by multi-path administrator and perform fine synchronization, then send the accurate multi-path position information to Rake receiver and send the feedback to multi-path administrator.

25. According to claim 24 of the forgoing code division multiple access receiver, its character is: the forgoing multi-path searcher further includes:
2-times baseband rate extractor, used to extract the 2 times baseband rate of the N-times sampling data;
Correlator, used to calculate the relevant value of the sample point;
Delay power spectrum generator, used to calculate the power spectrum of the relevant value of the sample point;
Initial detector, used to perform initial detection to the power spectrum of the sample point;
Peak detector, used to perform peak detection to the power spectrum of the sample point;
Data that is processed by receiving filter is extracted by the 2-times baseband rate extractor, then the data information of the 2-times oversampling is obtained. In the correlator, the relevant value of each sample point is calculated by the obtained data and the local tailing code. Relevant power detection is performed to each relevant value through the delay power spectrum generator, then successively through the initial detector and the peak detector.

26. According to claim 25 of the forgoing code division multiple access receiver, its character is: the forgoing peak detector further includes:
Power sequencer, used to sort the sample power Pi which is obtained by initial detection in sequential order, then successively send the sorted sample point power to the partial peak judger;
Partial peak judger, used to determine if Pi, Pi+3 are partial peaks, if at least Pi is determined to be a partial peak, trigger the partial peak detector to complete the partial peak detection;
Partial peak detector, used to perform partial single peak or double peak detection, and trigger the conjoint sample value detector after completing the peak detection;
Loop variable processor, used to initialize the loop variables or control the gradual increase of the loop variables;
Conjoint sample value detector, used to set the those power of the sample point whose power is larger than 0 but comparably less than its conjoint peak to 0, and control to complete the detection to all conjoint sample points;
Delay information processor, used to buffer and output the peak power information Pi of all larger-than-zero peak after the conjoint sample point detection and the corresponding delay information Ci.
